(19) United States
(12) Patent Application Publication
(10) Pub. No.: US 2007/0248058 A1
(43) Pub. Date: Oct. 25, 2007

(54) FAST LINK-DOWN DETECTION SYSTEMS AND METHODS

(76) Inventors: Victor Fajardo, Robbinsville, NJ (US); Yoshihiro Oba, Englewood Cliffs, NJ (US); Kenichi Tanuichi, Jersey City, NJ (US); Ashutosh Dutta, Bridgewater, NJ (US)

Correspondence Address: WATCHSTONE P + D, 1250 CONNECTICUT AVENUE, N.W., SUITE 700, WASHINGTON, DC, 20036, US

(21) Appl. No.: 11/379,569

(22) Filed: Apr. 20, 2006

(51) Int. Cl. H04Q 7/24

(52) U.S. Cl. 370/338

(57) ABSTRACT

The preferred embodiments describe an optimized method of determining “link down” indication from mobile or other non-access-point station (such as, e.g., an 802.11 non-access-point station) operating in managed mode. In the preferred embodiments, the method uses MAC layer operations for verifying communicability with an access point. This preferred methods can be used for, e.g., providing a fast “link down” event indication and can help in quickly assisting L3 protocols to take necessary actions.

### BACKGROUND

1. Field of the Invention

The present application relates to, inter alia, methods for determining link-down or failures in wireless communications, including, e.g., methods for determining link-down or failures in communications with wireless access point.

2. Background Discussion

Networks and Internet Protocol:

There are many types of computer networks, with the Internet having the most notoriety. The Internet is a worldwide network of computer networks. Today, the Internet is a public and self-sustaining network that is available to many millions of users. The Internet uses a set of communication protocols called TCP/IP (i.e., Transmission Control Protocol/Internet Protocol) to connect hosts. The Internet has a communications infrastructure known as the Internet backbone. Access to the Internet backbone is largely controlled by Internet Service Providers (ISPs) that resell access to corporations and individuals.

With respect to IP (Internet Protocol), this is a protocol by which data can be sent from one device (e.g., a phone, a PDA [Personal Digital Assistant], a computer, etc.) to another device on a network. There are a variety of versions of IP today, including, e.g., IPv4, IPv6, etc. Each host device on the network has at least one IP address that is its own unique identifier. IP is a connectionless protocol. The connection between end points during a communication is not continuous. When a user sends or receives data or messages, the data or messages are divided into components known as packets. Every packet is treated as an independent unit of data.

In order to standardize the transmission between points over the Internet or the like networks, an OSI (Open Systems Interconnection) model was established. The OSI model separates the communications processes between two points in a network into seven stacked layers, with each layer adding its own set of functions. Each device handles a message so that there is a downward flow through each layer at a sending end point and an upward flow through the layers at a receiving end point. The programming and/or hardware that provides the seven layers of function is typically a combination of device operating systems, application software, TCP/IP and/or other transport and network protocols, and other software and hardware.

Typically, the top four layers are used when a message passes from or to a user and the bottom three layers are used when a message passes through a device (e.g., an IP host device). An IP host is any device on the network that is capable of transmitting and receiving IP packets, such as a server, a router or a workstation. Messages destined for some other host are not passed up to the upper layers but are forwarded to the other host. The layers of the OSI model are listed below. Layer 7 (i.e., the application layer) is a layer at which, e.g., communication partners are identified, quality of service is identified, user authentication and privacy are considered, constraints on data syntax are identified, etc. Layer 6 (i.e., the presentation layer) is a layer that, e.g., converts incoming and outgoing data from one presentation format to another, etc. Layer 5 (i.e., the session layer) is a layer that, e.g., sets up, coordinates, and terminates conversations, exchanges and dialogs between the applications, etc. Layer-4 (i.e., the transport layer) is a layer that, e.g., manages end-to-end control and error-checking, etc. Layer-3 (i.e., the network layer) is a layer that, e.g., handles routing and forwarding, etc. Layer-2 (i.e., the data-link layer) is a layer that, e.g., provides synchronization for the physical level, does bit-stuffing and furnishes transmission protocol knowledge and management, etc. The Institute of Electrical and Electronics Engineers (IEEE) sub-divides the data-link layer into two further sub-layers, the MAC (Media Access Control) layer that controls the data transfer to and from the physical layer and the LLC (Logical Link Control) layer that interfaces with the network layer and interprets commands and performs error recovery. Layer 1 (i.e., the physical layer) is a layer that, e.g., conveys the bit stream through the network at the physical level. The IEEE sub-divides the physical layer into the PLCP (Physical Layer Convergence Procedure) sub-layer and the PMD (Physical Medium Dependent) sub-layer.

Wireless Networks:

Wireless networks can incorporate a variety of types of mobile devices, such as, e.g., cellular and wireless telephones, PCs (personal computers), laptop computers, wearable computers, cordless phones, pagers, headsets, printers, PDAs, etc. For example, mobile devices may include digital systems to secure fast wireless transmissions of voice and/or data. Typical mobile devices include some or all of the following components: a transceiver (i.e., a transmitter and a receiver, including, e.g., a single chip transceiver with an integrated transmitter, receiver and, if desired, other functions); an antenna; a processor; one or more audio transducers (for example, a speaker or a microphone as in devices for audio communications); electromagnetic data storage (such as, e.g., ROM, RAM, digital data storage, etc., such as in devices where data processing is provided); memory; flash memory; a full chip set or integrated circuit; interfaces (such as, e.g., USB, CODEC, UART, PCM, etc.); and/or the like.

Wireless LANs (WLANs) in which a mobile user can connect to a local area network (LAN) through a wireless connection may be employed for wireless communications. Wireless communications can include, e.g., communications that propagate via electromagnetic waves, such as light, infrared, radio, microwave. There are a variety of WLAN standards that currently exist, such as, e.g., Bluetooth, IEEE 802.11, and HomeRF.

By way of example, Bluetooth products may be used to provide links between mobile computers, mobile phones, portable handheld devices, personal digital assistants (PDAs), and other mobile devices and connectivity to the Internet. Bluetooth is a computing and telecommunications industry specification that details how mobile devices can easily interconnect with each other and with non-mobile devices using a short-range wireless connection. Bluetooth creates a digital wireless protocol to address end-user problems arising from the proliferation of various mobile devices that need to keep data synchronized and consistent from one device to another, thereby allowing equipment from different vendors to work seamlessly together. Bluetooth devices may be named according to a common naming concept. For example, a Bluetooth device may possess a Bluetooth Device Name (BDN) or a name associated with a unique Bluetooth Device Address (BDA). Bluetooth devices may also participate in an Internet Protocol (IP) network. If a Bluetooth device functions on an IP network, it may be provided with an IP address and an IP (network) name. Thus, a Bluetooth Device configured to participate on an IP network may contain, e.g., a BDN, a BDA, an IP address and an IP name. The term “IP name” refers to a name corresponding to an IP address of an interface.

An IEEE standard, IEEE 802.11, specifies technologies for wireless LANs and devices. Using 802.11, wireless networking may be accomplished with each single base station supporting several devices. In some examples, devices may come pre-equipped with wireless hardware or a user may install a separate piece of hardware, such as a card, that may include an antenna. By way of example, devices used in 802.11 typically include three notable elements, whether or not the device is an access point (AP), a mobile station (STA), a bridge, a PCMCIA card or another device: a radio transceiver; an antenna; and a MAC (Media Access Control) layer that controls packet flow between points in a network.

In addition, Multiple Interface Devices (MIDs) may be utilized in some wireless networks. MIDs may contain two independent network interfaces, such as a Bluetooth interface and an 802.11 interface, thus allowing the MID to participate on two separate networks as well as to interface with Bluetooth devices. The MID may have an IP address and a common IP (network) name associated with the IP address.

Wireless network devices may include, but are not limited to Bluetooth devices, Multiple Interface Devices (MIDs), 802.11 devices (IEEE 802.11 devices including, e.g., 802.11a, 802.11b and 802.11 g devices), HomeRF (Home Radio Frequency) devices, Wi-Fi (Wireless Fidelity) devices, GPRS (General Packet Radio Service) devices, 3G cellular devices, 2.5G cellular devices, GSM (Global System for Mobile Communications) devices, EDGE (Enhanced Data for GSM Evolution) devices, TDMA type (Time Division Multiple Access) devices, or CDMA type (Code Division Multiple Access) devices, including CDMA2000. Each network device may contain addresses of varying types including but not limited to an IP address, a Bluetooth Device Address, a Bluetooth Common Name, a Bluetooth IP address, a Bluetooth IP Common Name, an 802.11 IP Address, an 802.11 IP common Name, or an IEEE MAC address.

Wireless networks can also involve methods and protocols found in, e.g., Mobile IP (Internet Protocol) systems, in PCS systems, and in other mobile network systems. With respect to Mobile IP, this involves a standard communications protocol created by the Internet Engineering Task Force (IETF). With Mobile IP, mobile device users can move across networks while maintaining their IP Address assigned once. See Request for Comments (RFC) 3344. NB: RFCs are formal documents of the Internet Engineering Task Force (IETF). Mobile IP enhances Internet Protocol (IP) and adds means to forward Internet traffic to mobile devices when connecting outside their home network. Mobile IP assigns each mobile node a home address on its home network and a care-of-address (CoA) that identifies the current location of the device within a network and its subnets. When a device is moved to a different network, it receives a new care-of address. A mobility agent on the home network can associate each home address with its care-of address. The mobile node can send the home agent a binding update each time it changes its care-of address using, e.g., Registration Request MessageInternet Control Message Protocol (ICMP).

In basic IP routing (e.g., outside mobile IP), routing mechanisms rely on the assumptions that each network node always has a constant attachment point to, e.g., the Internet and that each node's IP address identifies the network link it is attached to. In this document, the terminology “node” includes a connection point, which can include, e.g., a redistribution point or an end point for data transmissions, and which can recognize, process and/or forward communications to other nodes. For example, Internet routers can look at, e.g., an IP address prefix or the like identifying a device's network. Then, at a network level, routers can look at, e.g., a set of bits identifying a particular subnet. Then, at a subnet level, routers can look at, e.g., a set of bits identifying a particular device. With typical mobile IP communications, if a user disconnects a mobile device from, e.g., the Internet and tries to reconnect it at a new subnet, then the device has to be reconfigured with a new IP address, a proper netmask and a default router. Otherwise, routing protocols would not be able to deliver the packets properly.

Link Layer Event Notifications:

Link-layer Event Notifications for Detecting Network Attachments (DNA), draft-ietf-dna-link-information-03.txt, I.E.T.F., A. Yegin, October, 2005, explains that: “It is not an uncommon occurrence for a node to change its point-of attachment to the network. This can happen due to mobile usage (e.g., a mobile phone moving among base stations) or nomadic usage e.g., road-warrior case). A node changing its point-of attachment to the network may end up changing its IP subnet and therefore require re-configuration of IP-layer parameters, such as IP address, default gateway information, and DNS server address. Detecting the subnet change can usually use network-layer indications such as a change in the advertised prefixes (i.e., appearance and disappearance of prefixes). But generally reliance on such indications does not yield rapid detection, since these indications are not readily available upon node changing its point of attachment. The changes to the underlying link-layer status can be relayed to IP in the form of link-layer event notifications. Establishment and tear down of a link-layer connection are two basic events types. Additional information can be conveyed in addition to the event type, such as the identifier of the network attachment point (e.g., IEEE 802.11 BSSID and SSID), or network-layer configuration parameters obtained via the link-layer attachment process if available. It is envisaged that such event notifications can in certain circumstances be used to expedite the inter-subnet movement detection and reconfiguration process. For example, the notification indicating that the node has established a new link-layer connection may be used for immediately probing the network for a possible configuration change. In the absence of such a notification from the link-layer, IP has to wait for indications that are not immediately available, such as receipt of next scheduled router advertisement, unreachability of the default gateway, etc. It should be noted that a link-layer event notification does not always translate into a subnet change. Even if the node has torn down a link-layer connection with one attachment point and established a new connection with another, it may still be attached to the same IP subnet. For example, several IEEE 802.11 access points can be attached to the same IP subnet. Moving among these access points does not warrant any IP-layer configuration change.”

The article further explains that: “In order to enable an enhanced scheme for detecting change of subnet, we need to define link-layer event notifications that can be realistically expected from various access technologies.”

The article further explains that: “These event notifications are considered with hosts in mind, although they may also be available on the network side (e.g., on the access points and routers). An API or protocol-based standard interface may be defined between the link-layer and IP for conveying this information. . . . Link-layer event notifications are considered to be one of the inputs to the DNA process. A DNA process is likely to take other inputs (e.g., presence of advertised prefixes, reachability of default gateways) before determining whether IP-layer configuration must be updated. It is expected that the DNA process can take advantage of link-layer notifications when they are made available to IP. While by itself a link-layer notification may not constitute all the input DNA needs, it can at least be useful for prompting the DNA process to collect further information (i.e., other inputs to the process). For example, the node may send a router solicitation as soon as it learns that a new link-layer connection is established.”

The article further explains that: “Two basic link-layer events are considered potentially useful to DNA process: link up and link down. Both of these events are deterministic, and their notifications are provided to IP-layer after the events successfully conclude. These events and notifications are associated with a network interface on the node. The IP module may receive simultaneous independent notifications from each one of the network interfaces on the node. “Link” is a communication facility or medium over which network nodes can communicate. Each link is associated with a minimum of two endpoints. An “attachment point” is the link endpoint on the link to which the node is currently connected, such as an access point, a base station, or a wired switch. “Link up” is an event provided by the link-layer that signifies a state change associated with the interface becoming capable of communicating data packets. This event is associated with a link-layer connection between the node and an attachment point. The actual event is managed by the link-layer of the node through execution of link-layer protocols and mechanisms. Once the event successfully completes within the link-layer, its notification must be delivered to the IP-layer. By the time the notification is delivered, the link-layer of the node MUST be ready to accept IP packets from the IP and the physical-layers. There is a non-deterministic usage of link up notification to accommodate implementations that desire to indicate the link is up but the data transmission may be blocked in the network (see IEEE 802.3 discussion). A link up notification MAY be generated with an appropriate attribute (e.g., “risk” indicated by R-flag) to convey the event. Alternatively, the link-layer implementation may choose to delay the link up notification until the risk conditions cease to exist. If a link up with the R-flag set was generated, another link up must follow up as soon as the link-layer is capable of generating a deterministic notification. The event attributes MUST indicate whether the packets transmitted since the previous notification were presumed to be blocked (B-flag) or allowed (A-flag) by the network if the link-layer could determine the exact conditions. If the link-layer cannot make a determination about the faith of these packets, it must generate a link up without any additional indications (no flags set).”

The article further explains that: “Link down” is an event provided by the link-layer that signifies a state change associated with the interface no longer being capable of communicating data packets. A link down event is only generated once the link-layer considers the link unusable; transient periods of high frame loss are not sufficient. When the link-layer connection is physically or logically torn down and it can no longer carry data packets, this is considered to be a link down event. Among these two events the first one to take place after an interface becomes enabled must be a link up event. During the time a network interface is enabled, it may go through a series of link up and down events. Each time the interface changes its point of attachment, a link down event with the previous attachment point must be followed by a link up event with the new one. Finally, when the network interface is disabled, this MUST generate a link down event. Each one of these events must generate a notification in the order they occur. A node may have to change its IP-layer configuration even when the link-layer connection stays the same. An example scenario is the IPv6 subnet renumbering [RFC2461]. Therefore, there exist cases where IP-layer configuration may have to change even without the IP-layer receiving a link up notification. Therefore, a link-layer notification is not a mandatory indication of a subnet change. In addition to the type of the event (link up, link down), a link-layer notification may also optionally deliver information relating to the attachment point. Such auxiliary information may include identity of the attachment point (e.g., base station identifier), or the IP-layer configuration parameters associated with the attached subnet (e.g., subnet prefix, default gateway address, etc.). While merely knowing that a new link-layer connection is established may prompt DNA process to immediately seek other clues for detecting network configuration change, auxiliary information may constitute further clues (and even the final answers sometimes). In cases where there is a one-to-one mapping between the attachment point identifiers and the IP-layer configurations, learning the former can reveal the latter. Furthermore, IP-layer configuration parameters obtained during link-layer connection may be exactly what the DNA process is trying to discover (e.g., IP address configured during PPP link establishment). The link-layer process leading to a link up or link down event depends on the link technology. While a link-layer notification must always indicate the event type, the availability and types of auxiliary information on the attachment point depends on the link-layer technology as well.”

### REFERENCES

The present invention provides a variety of advances and improvements over, among other things, the systems and methods described in the following references, the entire disclosures of which references are incorporated herein by reference.
[1] “Link Layer Hints for Detecting Network Attachement,” draft-yegin-dna-12-hints-00.txt, Alper Yegin, Eric Njedjou, Siva Veerepalli, Nicolas Montavont, Thomas Noel, I.E.T.F., April 2004.
[2] “Link Triggers Assisted Optimizations for Mobile IPv4/v6 Vertical Handovers,” Nicolas Montavont, Eric Njedjou, Franck Lebeugle, Thomas Noel, IEEE Computer, Society, October 2005.
[3] “Link Level Measurement for 802.11b Mesh Networks,” Daniel Aguayo, John Bicket, Sanjit Biswas, Glenn Judd, Robert Morris, MIT Computer Science and Artificiall Intelligence Labs, June 2004.
[4] “Link Adaptation Strategy for 802.11 WLAN via Receive Signal Strength Measurement,” Javier Del Prado Pavon, Sunghyun Choi, 2001.
[5] “IEEE 802.11b, Part 11 Wireless LAN Media Access Control (MAC) and Physical Layer (PHY) specification,” IEEE-SA Standard Board, 1999.
[6] “IEEE 802.11 g, Part 11 Wireless LAN Media Access Control (MAC) and Physical Layer (PHY) specification,” IEEE-SA Standard Board, 2003.
[7] “Techniques to recduce IEEE 802.11b MAC layer handover time,” Hector Velayos, Gunnar Karlsson, KTH Royal Institute of Technology, April 2003.
[8] “An empirical analysis of 802.11b MAC layer handover process,” Arunesh Mishra, Minho Shin, William Aurbaugh, University of Maryland Technical Report, 2002.
[9] “Link-layer Event Notifications for Detecting Network Attachments,” draft-ieff-dna-link-information-03.txt, I.E.T.F., A. Yegin, October, 2005.

### SUMMARY OF THE INVENTION

The present invention improves upon the above and/or other background technologies and/or problems therein.

According to some embodiments, a method for a mobile node to rapidly determine a sudden disconnection event from an access point in order to quickly propagate link-down indications includes: 1) having the mobile node passively scan transmissions from an access point to which it is authenticated and associated; and 2) having the mobile node transmit probe requests and actively scan for probe responses from the access point. In some examples, the step 1) includes having the mobile node monitor beacons from the access point and having the mobile node determine that a beacon is lost if the mobile node does not receive a beacon within a period of time. In addition, in some examples, the step 2) includes having the mobile node transmit probe requests at certain time intervals and actively scan for probe responses to the probe requests. In addition, in some examples, the method further includes having the mobile node normally perform the passive scanning in step 1) and, when the passive scanning results in a failure, having the mobile node perform the active scanning in step 2). In addition, in some examples, the method further includes having the mobile node combine the step 1) or the step 2) with monitoring of independent modifiers. In addition, in some examples, the monitoring of independent modifiers includes monitoring of application data traffic between the mobile node and the access point. Moreover, in some examples, the method further includes having the mobile node determine that a scan is successful if any frame is received from the access point even before passive and active scan thresholds have been reached and otherwise determine that a scan fails when passive and active scans fail without receipt of any frame. Moreover, in some examples, the method includes having the mobile node determine that a scan fails if application data transmission fails even before passive and active scan thresholds have been reached and otherwise that a scan succeeds if application data transmission succeeds even before passive and active scan thresholds have been reached.

According to other embodiments, a method for a mobile node to rapidly determine a sudden disconnection event from an access point in order to quickly propagate link-down indications includes: 1) having the mobile node passively scan transmissions from an access point to which it is authenticated and associated; and 2) having the mobile node combine the step 1) with monitoring of independent modifiers. In some examples, the monitoring of independent modifiers includes monitoring of application data traffic between the mobile node and the access point. In addition, in some examples, the method further includes having the mobile node determine that a passive scan is successful if any frame is received from the access point within a period and otherwise determine that a passive scan fails if a threshold is reached without receipt of any frame. In addition, in some examples, the method further includes having the mobile node determine that a passive scan fails if application data transmission fails and otherwise determine that a passive scan is successful if application data transmission succeeds, even if a certain threshold has not been reached. In addition, in some examples, the method further includes having the mobile node determine that a passive scan fails if application data transmission fails and otherwise determine that a passive scan is successful if application data transmission succeeds, even if a certain threshold has not been reached.

According to some other embodiments, a method for a mobile node to rapidly determine a sudden disconnection event from an access point in order to quickly propagate link-down indications includes: 1) having the mobile node transmit probe requests and actively scan for probe responses from the access point; and 2) having the mobile node combine the step 1) with monitoring of independent modifiers. In some examples, the monitoring of independent modifiers includes monitoring of application data traffic between the mobile node and the access point. In addition, in some examples, the method further includes having the mobile node determine that an active scan is successful if any frame is received from the access point even before a threshold is reached and otherwise determine that an active scan fails if the threshold is reached without receipt of any frame. In addition, in some examples, the method further includes having the mobile node determine that an active scan fails if application data transmission fails and otherwise determine that an active scan succeeds if application data transmission succeeds, even if a threshold has not been reached.

The above and/or other aspects, features and/or advantages of various embodiments will be further appreciated in view of the following description in conjunction with the accompanying figures. Various embodiments can include and/or exclude different aspects, features and/or advantages where applicable. In addition, various embodiments can combine one or more aspect or feature of other embodiments where applicable. The descriptions of aspects, features and/or advantages of particular embodiments should not be construed as limiting other embodiments or the claims.

### BRIEF DESCRIPTION OF THE DRAWINGS

The preferred embodiments of the present invention are shown by a way of example, and not limitation, in the accompanying figures, in which:

FIG. 1 is an architectural diagram showing exemplary sub-components of an illustrative access point and illustrative client devices or user stations according to some illustrative embodiments of the invention;

FIG. 2 is an architectural diagram showing an illustrative computer or control features that can be used to implement computerized process steps, to be carried out by devices, such as, e.g., an access point and/or a user station, in some embodiments of the invention;

FIG. 3 is an architectural diagram showing some transmission exchanges between a mobile node and an access point according to some illustrative embodiments; and

FIG. 4 is a schematic diagram showing a general overview of processes in some illustrative embodiments.

### DISCUSSION OF THE PREFERRED EMBODIMENTS

While the present invention may be embodied in many different forms, a number of illustrative embodiments are described herein with the understanding that the present disclosure is to be considered as providing examples of the principles of the invention and that such examples are not intended to limit the invention to preferred embodiments described herein and/or illustrated herein.

Illustrative Architecture

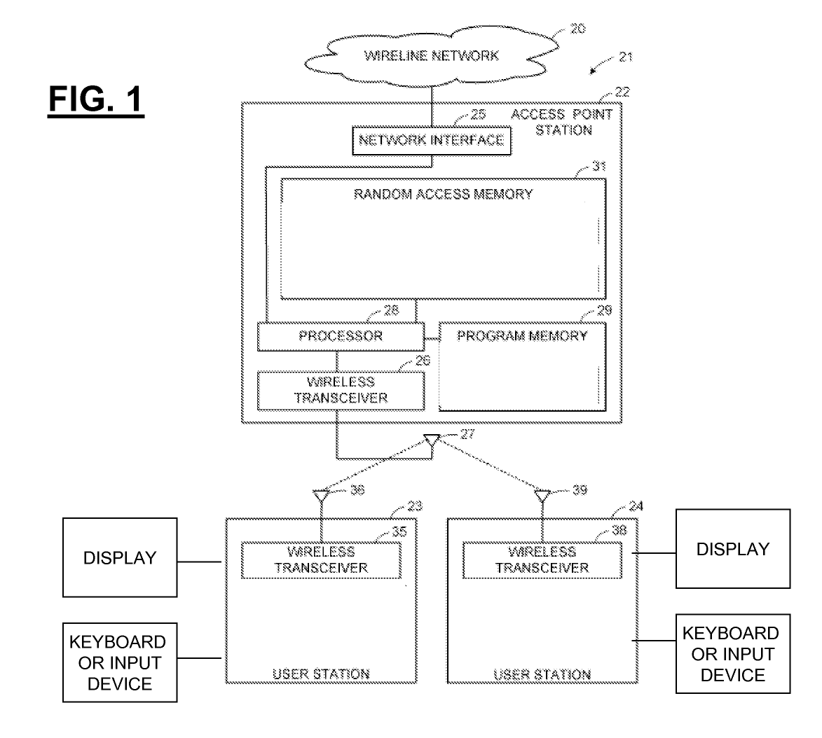

FIG. 1 depicts some illustrative architectural components that can be employed in some illustrative and non-limiting implementations including wireless access points to which client devices communicate. In this regard, FIG. 1 shows an illustrative wireline network 20 connected to a wireless local area network (WLAN) generally designated 21. The WLAN 21 includes an access point (AP) 22 and a number of user stations 23, 24. For example, the wireline network 20 can include the Internet or a corporate data processing network. For example, the access point 22 can be a wireless router, and the user stations 23, 24 can be, e.g., portable computers, personal desk-top computers, PDAs, portable voice-over-IP telephones and/or other devices. The access point 22 has a network interface 25 linked to the wireline network 21, and a wireless transceiver in communication with the user stations 23, 24. For example, the wireless transceiver 26 can include an antenna 27 for radio or microwave frequency communication with the user stations 23, 25. The access point 22 also has a processor 28, a program memory 29, and a random access memory 31. The user station 23 has a wireless transceiver 35 including an antenna 36 for communication with the access point station 22. In a similar fashion, the user station 24 has a wireless transceiver 38 and an antenna 39 for communication to the access point 22.

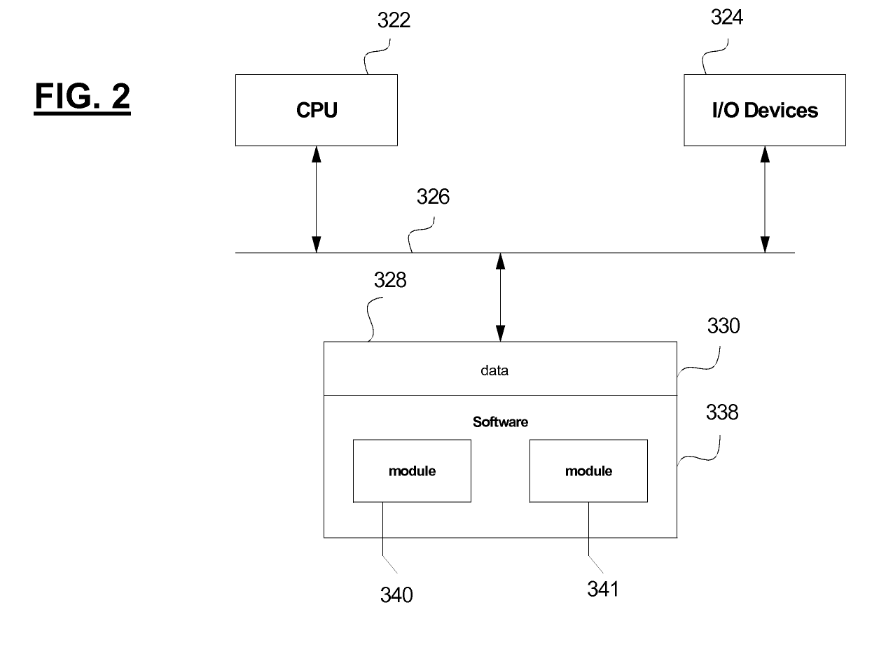

FIG. 2 shows an illustrative computer or control unit that can be used to implement computerized process steps, to be carried out by devices, such as, e.g., an access point and/or a user station, in some embodiments of the invention. In some embodiments, the computer or control unit includes a central processing unit (CPU) 322, which can communicate with a set of input/output (I/O) device(s) 324 over a bus 326. The I/O devices 324 can include, for example, a keyboard, monitor, and/or other devices. The CPU 322 can communicate with a computer readable medium (e.g., conventional volatile or non-volatile data storage devices) 328 (hereafter “memory 328”) over the bus 326. The interaction between a CPU 322, I/O devices 324, a bus 326, and a memory 328 can be like that known in the art. Memory 328 can include, e.g., data 330. The memory 328 can also store software 338. The software 338 can include a number of modules 340 for implementing the steps of processes. Conventional programming techniques may be used to implement these modules. Memory 328 can also store the above and/or other data file(s). In some embodiments, the various methods described herein may be implemented via a computer program product for use with a computer system. This implementation may, for example, include a series of computer instructions fixed on a computer readable medium (e.g., a diskette, a CD-ROM, ROM or the like) or transmittable to a computer system via and interface device, such as a modem or the like. The communication medium may be substantially tangible (e.g., communication lines) and/or substantially intangible (e.g., wireless media using microwave, light, infrared, etc.). The computer instructions can be written in various programming languages and/or can be stored in memory device(s), such as semiconductor devices (e.g., chips or circuits), magnetic devices, optical devices and/or other memory devices. In the various embodiments, the transmission may use any appropriate communications technology.

Discussion of the Preferred Embodiments

The preferred embodiments relate to an optimized method of determining “link down” indication from mobile node or other non-access-point station (such as, e.g., an 802.11 mobile node or other non-access-point station) operating in managed mode. In the preferred embodiments, the method uses MAC layer operations for verifying communicability with an access point (AP). This preferred methods can be used for, e.g., providing a fast “link down” event indication and can help in quickly assisting layer three (L3) protocols to take necessary actions.

In the present application, the following terminology is employed:

A “Non-Access-Point Station (non-AP STA)” includes, as indicated above a node acting as a station but not acting as an access point (such as, e.g., a mobile node or station). For example, a non-AP station can involve, e.g., an 802.11 node acting as a station but not acting as an access point.

An “Access Point (AP)” includes, e.g., a node that acts as an access point. For example, an AP can include, e.g., an 802.11 node acting as an access point.

A “distributed coordination function (DCF)” involves, e.g., a medium access protocol for, e.g., 802.11. See references [5] and [6] incorporated herein by reference above.

A “round-trip time (RTT)” involves a duration of time when a packet is transmitted from a source node toward a destination node to the time an acknowledgement is received from the destination node by the source node.

1. Introduction

In normal operations, a non-AP STA that is currently associated with an AP may experience sudden disconnection due to (a) device failure in the AP or (b) in the non-AP STA itself or (c) perhaps an un-anticipated rapid movement of the non-AP STA that quickly brings it out of range of the AP. Using signal quality to immediately determine “link down” events in the non-AP STA during these scenarios can be mis-leading since a non-AP STA documents the link quality based only on the last received framed. Therefore, link quality only represents historical data and it is reset only after a certain number of expected beacon frames have not been received. Other implementations verify connectivity using failed transmission events (RTS/CTS), see reference [7] incorporated herein by reference above. However, these implementation depends on whether an application is actually sending data; accordingly, they are not as reliable. For reference, a detailed measurement of link disconnection detection from different implementors is shown in reference [8] incorporated herein by reference above

According to some of the preferred embodiments discussed herein, methods are disclosed that enable rapid determining a sudden disconnection event in order to quickly propagate “link down” indications to L3 protocols such as, by way of example, MobileIP (see, e.g., reference [2] incorporated herein by reference above) that may be present in the non-AP STA. In some preferred embodiments, the methodologies can, e.g., quickly assist L3 protocols that rely exclusively on these indicators to perform specific actions such as, by way of example, detecting network attachment (DNA) (see, e.g., reference [1] incorporated herein by reference above). Among other things, a quick indication can provide better performance to L3 handoff procedures. In some of the preferred embodiments, the method uses a combined scheme of passive monitoring (e.g., of 802.11 frames—e.g., see references [5] and [6] incorporated herein by reference above) as well as active probing of the AP at certain conditions. In some of the preferred embodiments, a combination of these schemes can be employed. In yet some other of the preferred embodiments, monitoring of independent indicators is employed that provides several link-down detection variants applicable to different scenarios.

In this document, Link-Down events refer to, e.g., situations in which a link enters a link layer protocol state that is not associated with the ability to handle IP traffic or where there is a certain decline in link quality (such as, e.g., when a mobile node wanders out of range of an access point).

2. Preferred Algorithms

In some preferred embodiments, a fast disconnection algorithm provides a definitive measure that a complete link loss has occurred within a short period of time. Historically, definitive indicators have been ambiguous for wireless networks (such as, e.g., 802.11 networks) when considering very short time constraints (in the order of milli-seconds) because of, e.g., the following factors:

i. Signal strength can vary by, e.g., several decibels (dBs) when moving even just a short distance (e.g., a few meters). The low points of these fluctuations can cause a “false” indication of link loss during a short period of time.

ii. Un-stable packet loss rate can also cause “false” indications. For example, most 802.11 links have stable loss rate (see, e.g., reference [3] incorporated herein by reference above), though it is expected that there will be bursty periods of loss rate perhaps due to increased/bursty traffic demands.

iii. Propagation interference from an adjacent AP within or near the non-AP STA transmit channels. This relates to (ii) immediately above with packet loss rate at a high stable level. This is aggravated by, e.g., the DCF algorithm of 802.11 MAC (see, e.g., reference [4] incorporated herein by reference above) which may cause delay for any frame that requires an ACK.

iv. Multi-path Fading. Although this can contribute to (iii) immediately above, it is less likely to occur in more recent digital signal processing (DSP)/chipset implementations which can compensate for this effect.

The foregoing and other factors can contribute to “false” indications of link down events. In the preferred embodiments, algorithms are employed that compensate for these effects by, e.g., using MAC layer functions to establish a reasonable “level” of communicability with the AP and to define this “level” as a baseline for determining link disconnection. In the preferred embodiments, the method accomplishes this within a very short time frame based on the following assumptions:

i. That the non-AP STA is already successfully associated with and/or authenticated with the AP. In the preferred embodiments, the algorithm works only in an “Authenticated and Associated” state described in references [5] and [6] incorporated herein by reference above.

ii. That the non-AP STA is capable of sending/receiving control and data frames within a negotiated traffic rate. This becomes important when trying to determine a reasonable RTT (round trip time) between the non-AP STA and the AP. Control and data frames that require an acknowledgment (ACK) can be used as approximate measure of non-AP STA to AP RTT at a specific point in time.

iii. That the AP is sending beacon frames at known intervals. During the authentication and/or association phases, the non-AP STA and the AP exchange configuration variables (see, e.g., references [5] and [6] incorporated herein by reference above). This includes, e.g., using beacon frames from the AP which advertises a beacon interval (Target Beacon Transmission Times (TBTTs)) that the non-AP STA can use to approximate beacon frame arrival times from an AP.

iv. That a Re-association, Disassociation and/or De-authentication process will disable the link-down detection algorithm. The indicators for this process include any frames sent or received by the non-AP STA that is related to formal re-association, disassociation and/or de-authentication procedures.

Using these assumptions, fast link-down detection algorithms can be formed based on a combination of a basic set of schemes and a set of independent modifiers. In various embodiments, different combinations of these schemes and modifiers form differing link-down detection variants that can be used depending on what can be supported by the system. The following sections describe, among other things, a set of basic algorithms, algorithm parameters, and approximate detection time and issues related to their use. In additional, the succeeding sections herein-below describe some combinations that can be employed if the set of modifiers is applied to the basic algorithms.

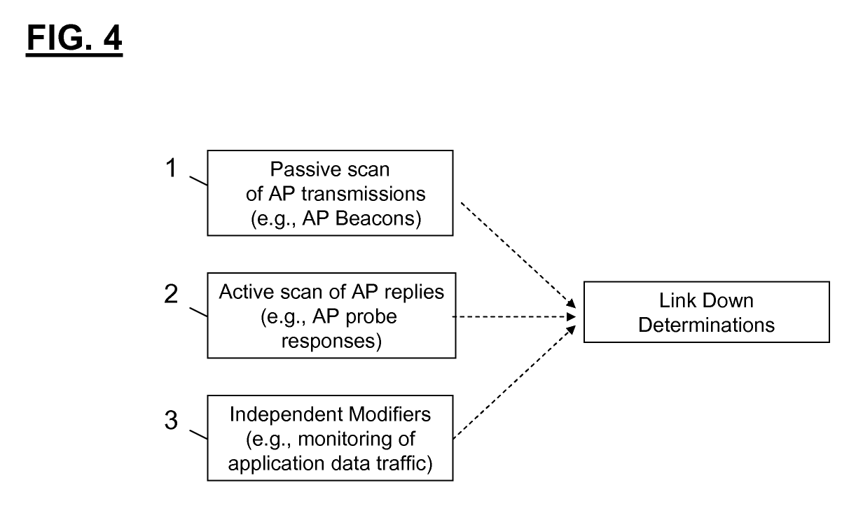

Referring now to FIG. 4, as set forth in greater detail below, in some of the preferred embodiments fast link-down detection algorithms are employed that employ passive scanning functionality 1, active scanning functionality 2 and/or independent modifiers (e.g., monitoring of application data traffic) functionality 3 in novel manners so as to achieve optimized link down determinations.

2.1. Basic Algorithm

2.1.1. Passive Scan

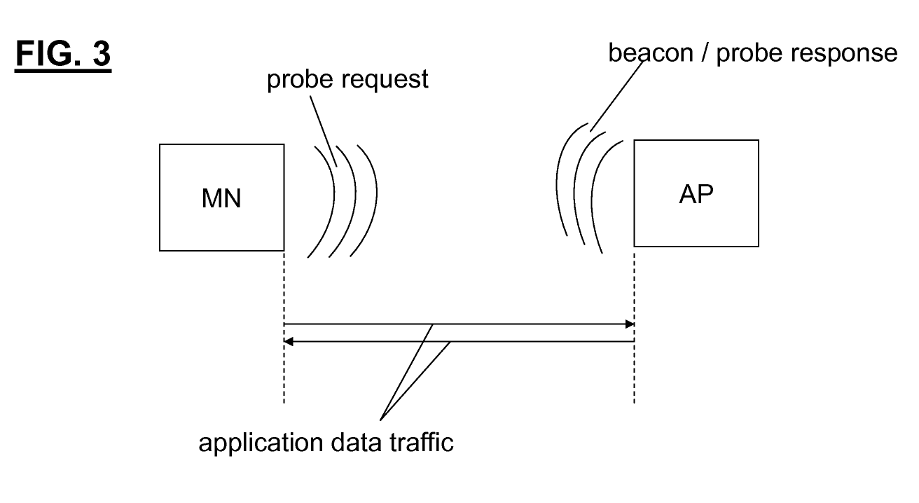

An non-AP STA counts the number of consecutive Beacon losses. In the preferred embodiments, a Beacon is considered as lost if the non-AP STA does not receive a Beacon for a period of time (T_B) since the last Beacon receipt or loss. Preferably, a passive scan is determined as being failed if the number of consecutive Beacon losses reaches a certain threshold (N_B). In some embodiments, the link is considered to be down when passive scan fails. To facilitate reference, FIG. 3 depicts an illustrative mobile node MN and an illustrative access point AP, with Beacon transmissions schematically illustrated.

In these embodiments, the following parameters are, thus, of interest: 1) time period T_B (which depends on TBTT) and 2) threshold value N_B. Here, the detection time can be written as: T_B*N_B.

In these embodiments, the following issues are presented.

a. There is a slow detection speed occurs if T_B or N_B is too large.

b. There are too many Beacons occur if T_B is too small.

c. There is an increased probability of false link down detection occurs if N_B is too small.

2.1.2. Active Scan

In some examples, a Non-AP STA transmits (e.g., unicasts) a probe request every interval of time (T_P) (e.g., the Non-AP STA retransmits the probe request continuously on a periodic basis every time interval T_P). Preferably, active scanning is determined to have failed if the number of transmissions reaches a threshold number (N_P) and no probe response(s) have been received. If at least one probe response is received before N_P is reached, then active scanning is determined to have succeeded. On the other hand, the link is considered to be down when the active scanning fails. To facilitate reference, FIG. 3 depicts an illustrative mobile node MN and an illustrative access point AP, with probe requests and probe responses schematically illustrated.

In these embodiments, the following parameters are, thus, of interest: 1) time period T_P (which depends on RTT) and 2) threshold number N_P. Here, the detection time can be written as: T_P*N_P.

In these embodiments, the following issues are presented.

a. There is too much probe traffic if T_P is too small.

b. There is an increased probability of false link down detection if N_P is too small.

c. There is a slow detection speed if T_P or N_P is too large

2.1.3. Hybrid Scan

In some embodiments, an non-AP STA would normally perform passive scanning. Then, when the passive scan reports a failure, the non-AP STA would start an active scan instead of immediately determining that the link is down. Preferably, the link is considered to be down if the active scan fails. On the other hand, if the active scan succeeds, the non-AP STA preferably switches back to passive scanning.

In these embodiments, the following parameters are of interest: T_B; N_B; T_P; and N_P. Here, it is noted that T_B can be independent of TBTT.

In addition, in these embodiments, the total detection time can be written as T_B*N_B+T_P*N_P.

In these embodiments, the following issues are presented. Although this combination should lessen the chance of false detection compared to a passive scan or an active scan alone, in a heavily loaded condition, the chances of a false detection can increase over a lightly loaded condition for the same pair of N_B and N_P values.

2.2. Independent Modifiers

In some embodiments, independent modifiers are employed to enhance the determination processes. In some exemplary embodiments, traffic flows are considered independent modifiers because they directly affect the basic set of algorithms. In this regard, traffic flows can include application traffic transmissions between the non-AP STA and the AP. For reference, FIG. 2 schematically depicts illustrative application traffic transmissions between a mobile node (e.g., a non-AP STA) and an AP. In some preferred embodiments, these modifiers are added to, e.g., the basic algorithms so as to produce variants that use sent and/or received frames or other transmissions as replacement indicators for, e.g., beacon and/or probe responses, such as, e.g., discussed below. For reference, a frame includes, e.g., data that is transmitted between network points and typically includes addressing and necessary protocol control information. Typically, a frame includes a header and a trailer that “frame” the data. In some examples, some control frames do no contain data.

2.2.1. Received Frame

In some embodiments, the receipt of any frame can be considered as receipt of a beacon frame or probe response. Therefore, a passive or active scan is considered successful if any frame is received from the access point (AP). Among other things, this takes advantage of heavily loaded conditions where beacons or probe responses can get lost and trigger a false link down event.

2.2.2. Transmission Failure

In some preferred embodiments, a failure to transmit a data frame can be used as an indication of link failure. Under, e.g., 802.11 MAC, each data frame sent by a non-AP STA requires an acknowledgement (ACK) from the access point (AP). The non-AP STA will retransmit the data frame if an ACK is not received within a certain amount of time (normally implementation specific). Preferably, the link is considered down if the number of attempts or retries exceeds a configured threshold (also implementation specific).

2.3. Preferred Variant Algorithms

In preferred embodiments, the independent modifiers are not employed as wholly independent solutions because they rely on applications generating data traffic. In preferred embodiments employing independent modifiers, they are combined with the basic algorithms to produce one or more of several variants. In various embodiments, one or more of these variants can be used as actual solutions to fast link down detection based on preference, scalability and/or implementation considerations. Using these variants can help to reduce false link-down detection caused by, e.g., heavy traffic conditions since such use can take advantage of, e.g., ongoing traffic exchanges. In some illustrative embodiments, these modifiers can be combined with each basic algorithm as shown below:

2.3.1. Passive Scan Combined with Modifiers

In some preferred embodiments, passive scanning combined with both modifiers can achieve one or more of the following variants:

a. Received frame (2.2.1) variant. In some embodiments, a passive scan can be determined to be successful if any frame is received from the access point (AP) within T_B*N_B. Otherwise, the passive scan fails if the N_B threshold is reached without receipt of any frame. Here, any received frame becomes a substitute for an expected beacon frame.

b. Transmission failure (2.2.2) variant. In some embodiments, a passive scan fails if data transmission fails even if N_B has not yet been reached. Similarly, a passive scan succeeds if data transmission succeeds even if N_B has not yet been reached. If no non-AP STA application is generating data, the passive scan proceeds as normal (see 2.1.1).

c. Received frame (2.2.1) and Transmission failure (2.2.2) variant. In some embodiments, a passive scan fails if (a) OR (b) above in this section fails. Similarly, a passive scan succeeds if (a) OR (b) succeeds. Preferably, the detection time is determined by which failure occurs first (i.e., (a) or (b)).

2.3.2. Active Scan Combined with Modifiers

In some preferred embodiments, active scanning combined with both modifiers can achieve one or more of the following variants:

a. Received frame (2.2.1) variant. In some embodiments, an active scan is deemed successful if any frame is received from the AP even before the N_P is reached. Otherwise, the active scan preferably fails if the N_P threshold is reached without receipt of any frame. In this regard, any received frame, thus, becomes a substitute to the expected probe response.

b. Transmission failure (2.2.2) variant. In some embodiments, an active scan is deemed to fail if data transmission fails even if N_P has not yet been reached. Similarly, an active scan is deemed to succeed if data transmission succeeds even if N_P has not yet been reached. Preferably, if no application of the non-AP STA is generating data, the active scan proceeds as normal (see 2.1.2).

c. Received frame (2.2.1) and Transmission failure (2.2.2) variant. In some embodiments, an active scan is determined to fail if (a) OR (b) of this section fails. Similarly, an active scan is determined to succeed if (a) OR (b) succeeds. Preferably, the detection time is determined by which failure occurs first (e.g., (a) or (b)).

2.3.3. Hybrid Scan Combined with Modifiers

In some embodiments, the detection scheme described above in Section 2.1.3 can be combined with the foregoing modifiers so as to result in one or more of the following variants:

a. Received frame (2.2.1) variant. In some embodiments, a hybrid scan is deemed to be successful if any frame is received from the AP even before the passive AND active scan thresholds have been reached. Here, the receipt of any frame preferably constitutes a receipt of an expected beacon or probe response. Preferably, the hybrid scan is deemed to fail when the passive and subsequent active scan fail without the receipt of any frame(s).

b. Transmission failure (2.2.2) variant. In some embodiments, a hybrid scan is determined to fail if data transmission fails even before the passive AND the active scan thresholds have been reached. Similarly, a hybrid scan is preferably determined to succeed if the data transmission succeeds even before the passive scan AND the active scan thresholds have been reached. Preferably, if no application of the non-AP STA is generating data, the hybrid scan proceeds as normal (see 2.1.3).

c. Received frame (2.2.1) and Transmission failure (2.2.2) variant. In some embodiments, a hybrid scan is determined to fail if (a) OR (b) of this section fails. Similarly, a hybrid scan is preferably determined to succeed if (a) OR (b) succeeds. Here, the detection time is determined by which failure occurs first (e.g., (a) or (b)).

Broad Scope of the Invention:

While illustrative embodiments of the invention have been described herein, the present invention is not limited to the various preferred embodiments described herein, but includes any and all embodiments having equivalent elements, modifications, omissions, combinations (e.g., of aspects across various embodiments), adaptations and/or alterations as would be appreciated by those in the art based on the present disclosure. The limitations in the claims (e.g., including that to be later added) are to be interpreted broadly based on the language employed in the claims and not limited to examples described in the present specification or during the prosecution of the application, which examples are to be construed as non-exclusive. For example, in the present disclosure, the term “preferably” is non-exclusive and means “preferably, but not limited to.” In this disclosure and during the prosecution of this application, means-plus-function or step-plus-function limitations will only be employed where for a specific claim limitation all of the following conditions are present in that limitation: a) “means for” or “step for” is expressly recited; b) a corresponding function is expressly recited; and c) structure, material or acts that support that structure are not recited. In this disclosure and during the prosecution of this application, the terminology “present invention” or “invention” may be used as a reference to one or more aspect within the present disclosure. The language present invention or invention should not be improperly interpreted as an identification of criticality, should not be improperly interpreted as applying across all aspects or embodiments (i.e., it should be understood that the present invention has a number of aspects and embodiments), and should not be improperly interpreted as limiting the scope of the application or claims. In this disclosure and during the prosecution of this application, the terminology “embodiment” can be used to describe any aspect, feature, process or step, any combination thereof, and/or any portion thereof, etc. In some examples, various embodiments may include overlapping features. In this disclosure, the following abbreviated terminology may be employed: “e.g.” which means “for example.”

What is claimed is:

1. A method for a mobile node to rapidly determine a sudden disconnection event from an access point in order to quickly propagate link-down indications, comprising the steps of:
1) having the mobile node passively scan transmissions from an access point to which it is authenticated and associated, including having said mobile node monitor beacons from the access point and having said mobile node determine that a beacon is lost if the mobile node does not receive a beacon within a period of time;
2) having the mobile node transmit probe requests and actively scan for probe responses from the access point, including having said mobile node monitor beacons from the access point and having said mobile node determine that a beacon is lost if the mobile node does not receive a beacon within a period of time; and
3) further including having said mobile node normally perform said passive scanning in step 1) and, when said passive scanning results in a failure, having said mobile node perform said active scanning in step 2).

2. The method of claim 1, further including having the mobile node combine said step 1) or said step 2) with monitoring of independent modifiers.

3. The method of claim 2, wherein said monitoring of independent modifiers includes monitoring of application data traffic between the mobile node and the access point.

4. A method for a mobile node to rapidly determine a sudden disconnection event from an access point in order to quickly propagate link-down indications, comprising the steps of:
1) having the mobile node passively scan transmissions from an access point to which it is authenticated and associated, including having said mobile node monitor beacons from the access point and having said mobile node determine that a beacon is lost if the mobile node does not receive a beacon within a period of time;
2) having the mobile node transmit probe requests and actively scan for probe responses from the access point, including having said mobile node monitor beacons from the access point and having said mobile node determine that a beacon is lost if the mobile node does not receive a beacon within a period of time; and
3) further including having the mobile node combine said step 1) or said step 2) with monitoring of independent modifiers.

5. The method of claim 4, wherein said monitoring of independent modifiers includes monitoring of application data traffic between the mobile node and the access point.

6. The method of claim 5, further including having said mobile node determine that a scan is successful if any frame is received from the access point even before passive and active scan thresholds have been reached and otherwise determine that a scan fails when passive and active scans fail without receipt of any frame.

7. The method of claim 5, further including having said mobile node determine that a scan fails if application data transmission fails even before passive and active scan thresholds have been reached and otherwise that a scan succeeds if application data transmission succeeds even before passive and active scan thresholds have been reached.

8. A mobile node configured to perform the method of claim 4, wherein said mobile node is configured to passively scan transmissions from an access point to which it is authenticated and associated and to transmit probe requests and actively scan for probe responses from the access point.

9. A method for a mobile node to rapidly determine a sudden disconnection event from an access point in order to quickly propagate link-down indications, comprising the steps of:
1) having the mobile node passively scan transmissions from an access point to which it is authenticated and associated; and
2) having the mobile node combine said step 1) with monitoring of independent modifiers.

10. The method of claim 9, wherein said monitoring of independent modifiers includes monitoring of application data traffic between the mobile node and the access point.

11. The method of claim 10, further including having said mobile node determine that a passive scan is successful if any frame is received from the access point within a period and otherwise determine that a passive scan fails if a threshold is reached without receipt of any frame.

12. The method of claim 10, further including having the mobile node determine that a passive scan fails if application data transmission fails and otherwise determine that a passive scan is successful if application data transmission succeeds, even if a certain threshold has not been reached.

13. The method of claim 11, further including having the mobile node determine that a passive scan fails if application data transmission fails and otherwise determine that a passive scan is successful if application data transmission succeeds, even if a certain threshold has not been reached.

14. A mobile node configured to perform the method of claim 9, wherein said mobile node is configured to passively scan transmissions from an access point to which it is authenticated and associated and to monitor application data traffic between the mobile node and the access point.

15. A method for a mobile node to rapidly determine a sudden disconnection event from an access point in order to quickly propagate link-down indications, comprising the steps of:
1) having the mobile node transmit probe requests and actively scan for probe responses from the access point; and
2) having the mobile node combine said step 1) with monitoring of independent modifiers.

16. The method of claim 15, wherein said monitoring of independent modifiers includes monitoring of application data traffic between the mobile node and the access point.

17. The method of claim 15, further including having the mobile node determine that an active scan is successful if any frame is received from the access point even before a threshold is reached and otherwise determine that an active scan fails if the threshold is reached without receipt of any frame.

18. The method of claim 15, further including having the mobile node determine that an active scan fails if application data transmission fails and otherwise determine that an active scan succeeds if application data transmission succeeds, even if a threshold has not been reached.
